(19) United States
(12) Patent Application Publication
(10) Pub. No.: US 2023/0297889 A1
(43) Pub. Date: Sep. 21, 2023

(54) METHODS AND SYSTEMS FOR DEPLOYING AN ARTIFICIAL WORKFORCE

(71) Applicant: Artificial Compute, Inc., Austin, TX (US)

(72) Inventor: Richard Lopez, JR., Buda, TX (US)

(21) Appl. No.: 18/187,399

(22) Filed: Mar. 21, 2023

Related U.S. Application Data
(60) Provisional application No. 63/322,114, filed on Mar. 21, 2022.

(51) Int. Cl. G06N 20/00; G06N 5/022; G06N 7/01

(52) U.S. Cl. CPC G06N 20/00; G06N 5/022; G06N 7/01

(57) ABSTRACT

Provided is a method and system for generating artificial compute agents by receiving a request for an agent, the request including a set of one or more tasks to be automatically completed by the agent; obtaining, from a database, one or more preconfigured commands for performing the set of one or more tasks; generating, using the one or more preconfigured commands, a virtual agent configured to perform the one or more preconfigured commands; and providing an indication that the agent is configured to perform the set of one or more tasks and available for deployment.

### CROSS-REFERENCE TO RELATED APPLICATIONS

The present patent claims the benefit of priority to U.S. Provisional Patent Application 63/322,114, filed 21 Mar. 2022, titled “Methods and Systems for Designing Artificial Employees,” the contents of which are hereby incorporated by reference in its entirety.

### BACKGROUND

The present disclosure relates generally to artificial intelligence, and, more specifically, to improved forms of human-computer-interaction design that facilitate use of software tools to generate machine-learning models by lay people.

### SUMMARY

The following is a non-exhaustive listing of some aspects of the present techniques. These and other aspects are described in the following disclosure.

Some aspects include a process that includes receiving, from a computing device, a request for an agent, the request including a set of one or more tasks to be automatically completed by the agent, obtaining, from a database associated with the computing device, one or more preconfigured commands for performing the set of one or more tasks. The process further includes generating, using the one or more preconfigured commands, a virtual agent configured to perform the one or more preconfigured commands, and providing an indication that the agent is configured to perform the set of one or more tasks and available for deployment.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE SEVERAL VIEWS OF THE DRAWINGS

The above-mentioned aspects and other aspects of the present techniques will be better understood when the present application is read in view of the following figures in which like numbers indicate similar or identical elements.

FIG. 1A illustrates an embodiment of a graphical user interface for an artificial compute agent creation process in accordance with some embodiments.

FIG. 1B illustrates an embodiment for creating an artificial compute agent (e.g., non-human worker) of a specific type (e.g., software developer) in accordance with some embodiments.

FIG. 1C illustrates an embodiment for specifying different tasks to be handled by artificial compute agents (e.g., non-human workers) in accordance with some embodiments.

FIG. 1D illustrates a process for generating an artificial compute agent including providing data integration points in accordance with some embodiments.

FIG. 1E illustrates a dashboard for communication between a user and an artificial compute agent in accordance with some embodiments.

FIG. 1F illustrates a process based on communication channels from FIG. 1E; communication channels serve as additional data ingestion points to build out work-specific artificial intelligence/machine learning models in accordance with some embodiments.

FIG. 1G illustrates a process for automatically assigning an email identification for making communication with non-human workers easier in accordance with some embodiments.

FIG. 1H illustrates a process and design for communication with non-human workers in accordance with some embodiments.

FIG. 1I illustrates a second artificial compute agent in accordance with some embodiments.

FIG. 1J illustrates a process and design for creating many artificial compute agents in accordance with some embodiments.

FIG. 1K illustrates a user interface displaying information pertaining to artificial compute agents in accordance with some embodiments.

FIG. 1L illustrates a process for integration with third-party tools and services that are used for completing and defining tasks in accordance with some embodiments.

FIG. 1M illustrates a dashboard view of metrics and data for comparing non-human worker to human worker contribution and performance in accordance with some embodiments.

FIG. 1N illustrates a training process for an artificial compute agent in accordance with some embodiments.

FIG. 2 illustrates a block diagram depicting a process for designing and deploying an artificial compute agent in accordance with some embodiments.

FIG. 3 is a diagram that illustrates an example computing system 300 in accordance with some embodiments of the present technique.

FIG. 4 is a block diagram illustrating a process for generating artificial compute agents in accordance with some embodiments.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

To mitigate the problems described herein, the inventors had to both invent solutions and, in some cases just as importantly, recognize problems overlooked (or not yet foreseen) by others in the fields of artificial intelligence and human-computer interaction. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Machine learning and other forms of artificial intelligence often allow computers to perform tasks and functions that traditionally, humans performed. Improvements in this technology often allow humans to focus on complicated, interdisciplinary problems that machines cannot solve quite yet.

Digital work automation solutions include background services, jobs automation, task runners, and, more recently, Robotic Process Automation (RPA). These technologies, in some use cases, deliver task automation for digital systems. The design of these processes includes data mining, process definition, coding of automation scripts, task orchestration, computer execution of automation code, monitoring the execution of automation code, and maintenance of automation code. One significant setback of these automation solutions is that they require considerable customer coding and technical expertise (which is not to suggest that such approaches are disclaimed). This level of sophistication can be a barrier for users who are not highly familiar with software development and coding concepts. Such solutions are also limited by their reliance on manual process discovery and access to customer data streams.

Still, despite the breakneck speed of innovation in machine learning and artificial intelligence more generally, it is still difficult for a layperson to generate machine learning models. To mitigate this issue, some embodiments implement user interfaces and natural language processing techniques that assist a layperson as they configure a machine learning model to perform workplace tasks.

Hiring suitable workers for a job position incurs costs of time, money, and resources. Oftentimes, it may take weeks or months to find a suitable employee. After finding said suitable employee, it may take weeks or months to train the employee to be productive and to become integrated within the organization. Additionally, workers with considerable experience and knowledge may depart the organization and thus incur further costs to replace the departed worker.

Rather than incurring time, experience, and other associated costs for traditional, human workers, non-human employees may be implemented by lay-users with some embodiments. Non-human employees may include artificial intelligence software programs that can perform tasks like those a human employee might manage. For example, a non-human AI software developer may code a specific algorithm responsive to an unstructured natural language prompt by a lay user. In another example, a non-human assistant may organize and administer tasks, such as calendaring meetings, taking notes, updating logs, and other similar tasks.

As such, methods and systems for creating, training, and deploying an Artificial Workforce, which combines various artificial intelligence and digital automation techniques with human employee domain knowledge into a single unit of executable code called an Artificial Compute Agent are contemplated herein. These systems and methods include but are not limited to (which is not to suggest that any other list is limiting) using artificial intelligence, computers, storage devices, and digital networks to find optimal (or improved) steps to complete traditional human-computer interactions automatically on computer-like machines. In some implementations, a digital device, such as a computing device, is configured to automatically complete tasks in a method that mimics human users' comparable actions taken on similar digital devices (though with a fundamentally different computational process that would occur in mental steps in some embodiments). In some embodiments, a computing device is configured to automatically complete a portion of related work tasks in a method that mimics users' comparable actions done on similar digital devices, allowing manual human intervention to complete the associated tasks. Some embodiments provide automation solutions by reducing the associated costs, improving the performance of automation processes, and reducing technical barriers to implementing digital work automation. The system, as described, enables users to interact with digital automation solutions similar to how users approach human employees, making it more accessible to integrate digital automation solutions.

Machine learning may be used for generating models by which such “employees” are implemented. By using machine learning algorithms to build models, in some embodiments, artificial compute agents may be trained to make decisions without human intervention. Machine learning techniques, in some embodiments, are expected to provide artificial compute agents the ability to act based on learned observations which help artificial compute agents continuously improve in providing better service.

The artificial compute agents, in some embodiments, can be generated using machine learning principals, statistical inference, or artificial intelligence principals, which is not to suggest that these approaches do not overlap.

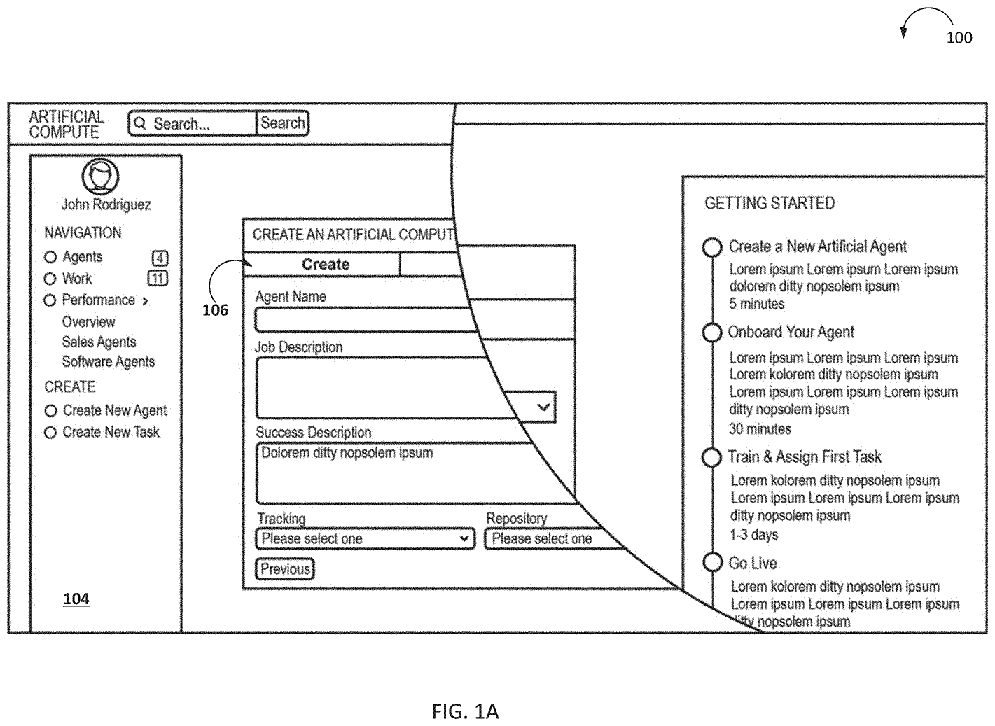

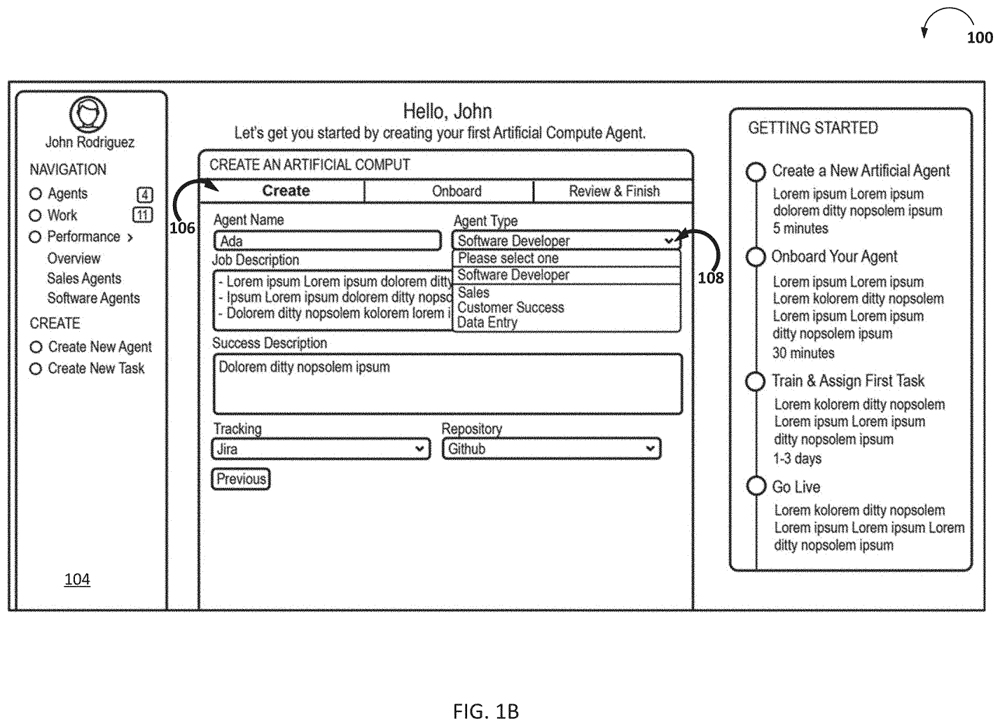

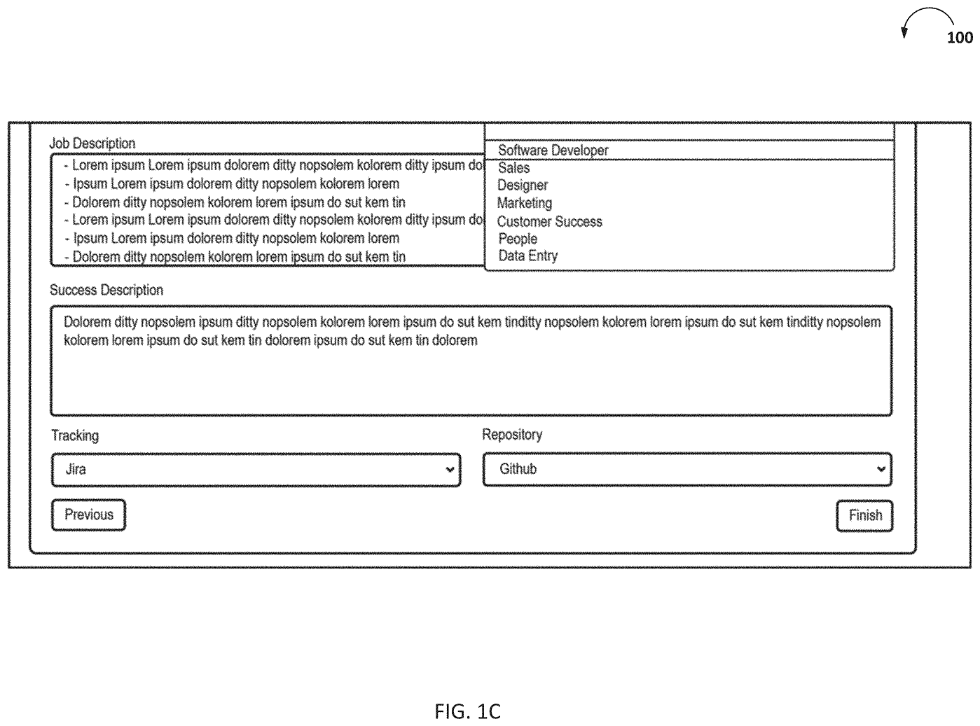

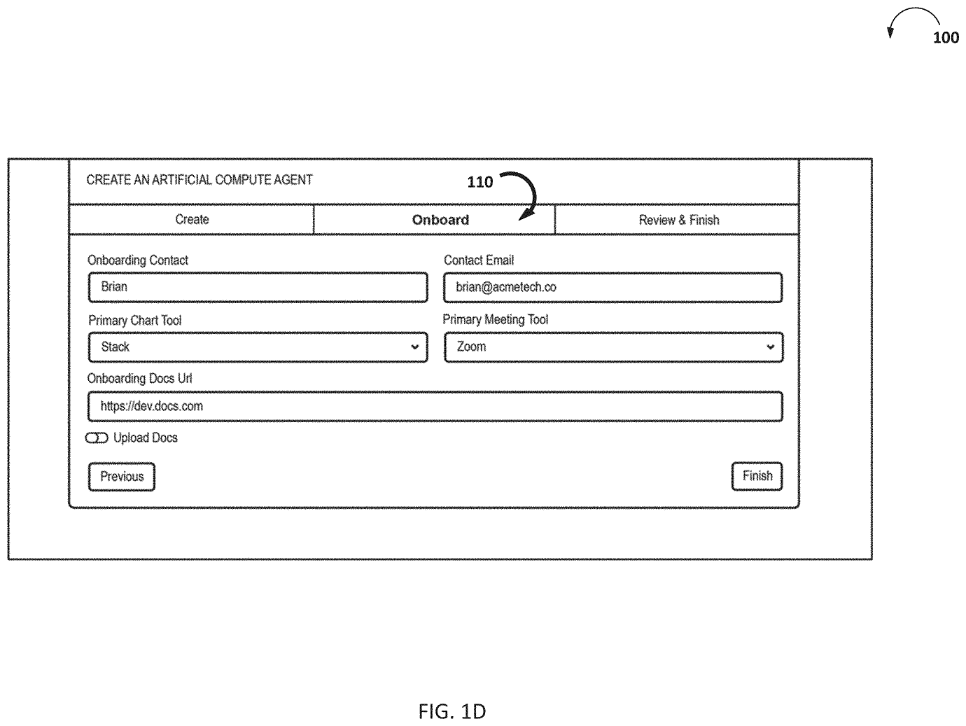

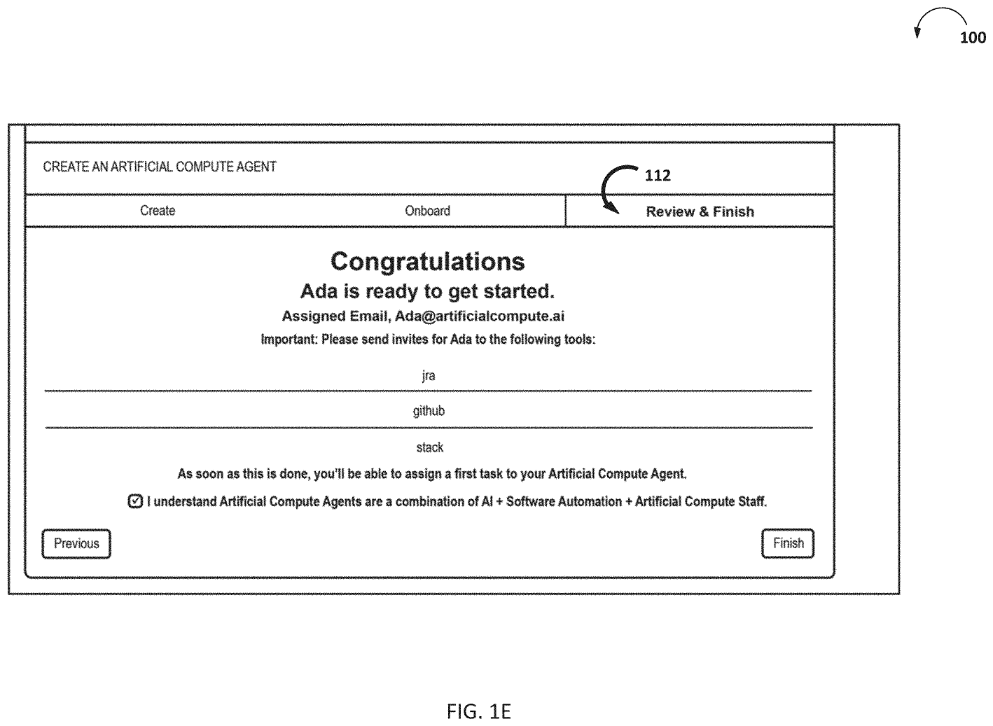

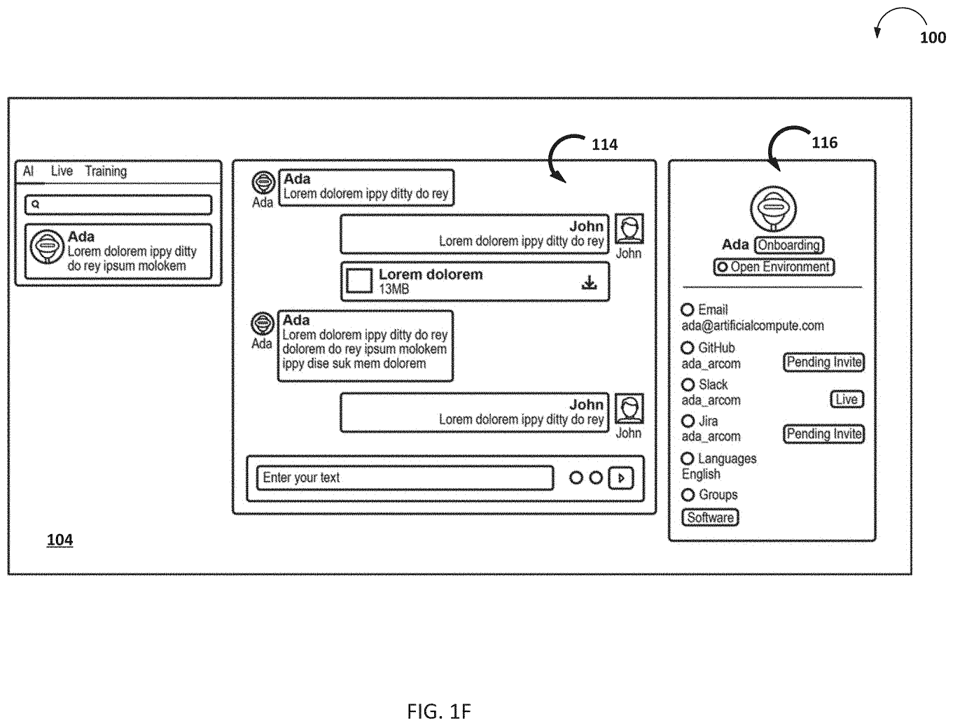

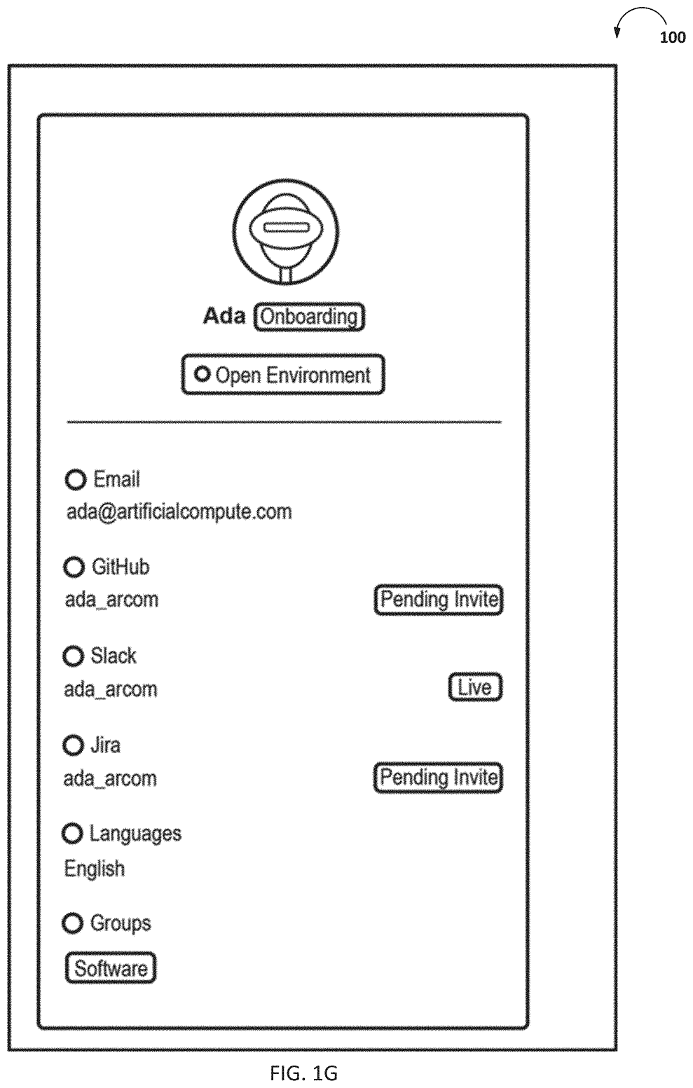

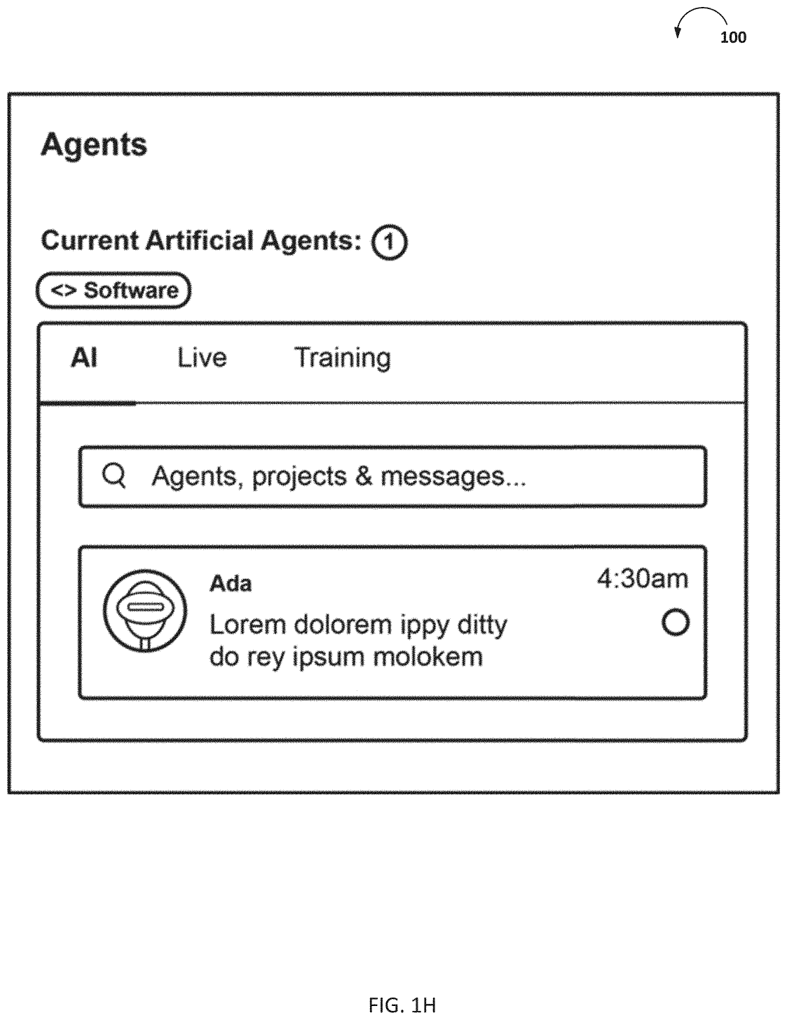

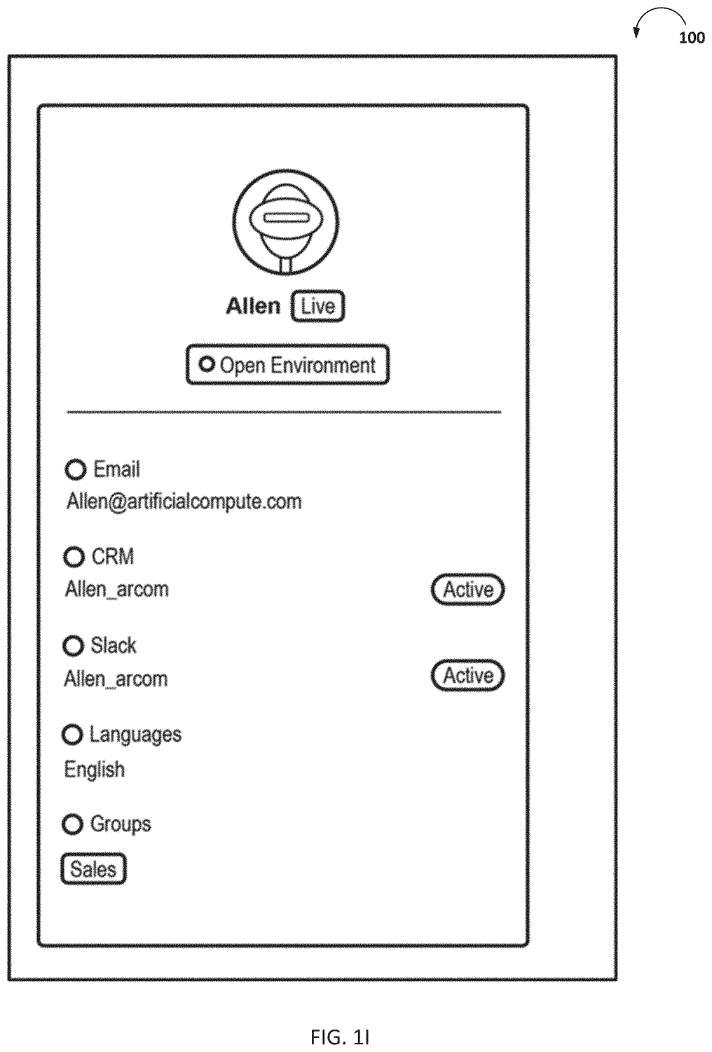

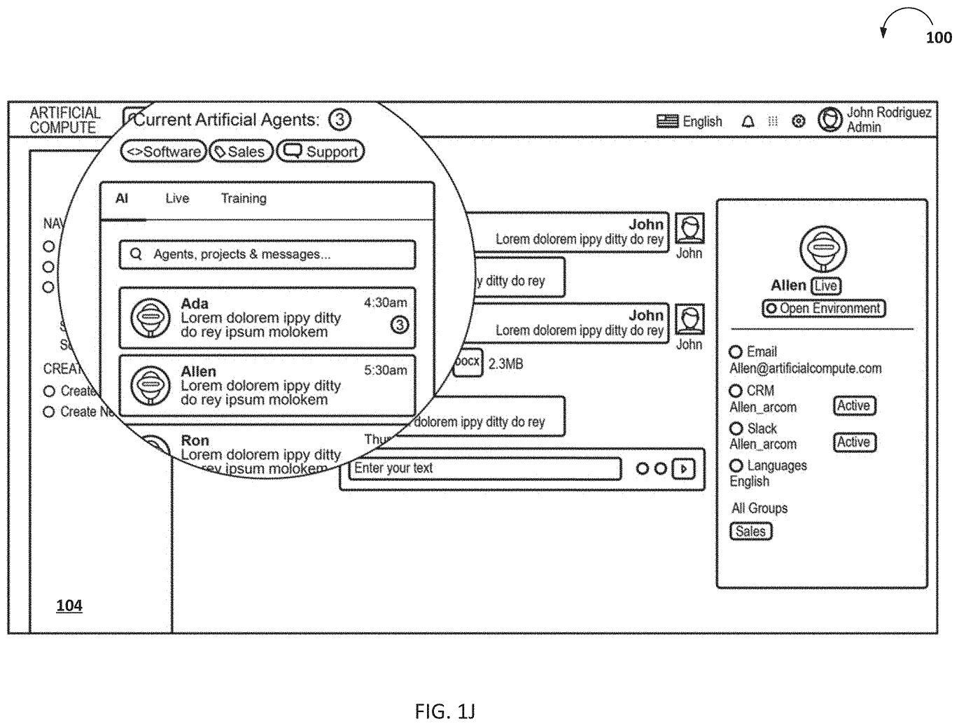

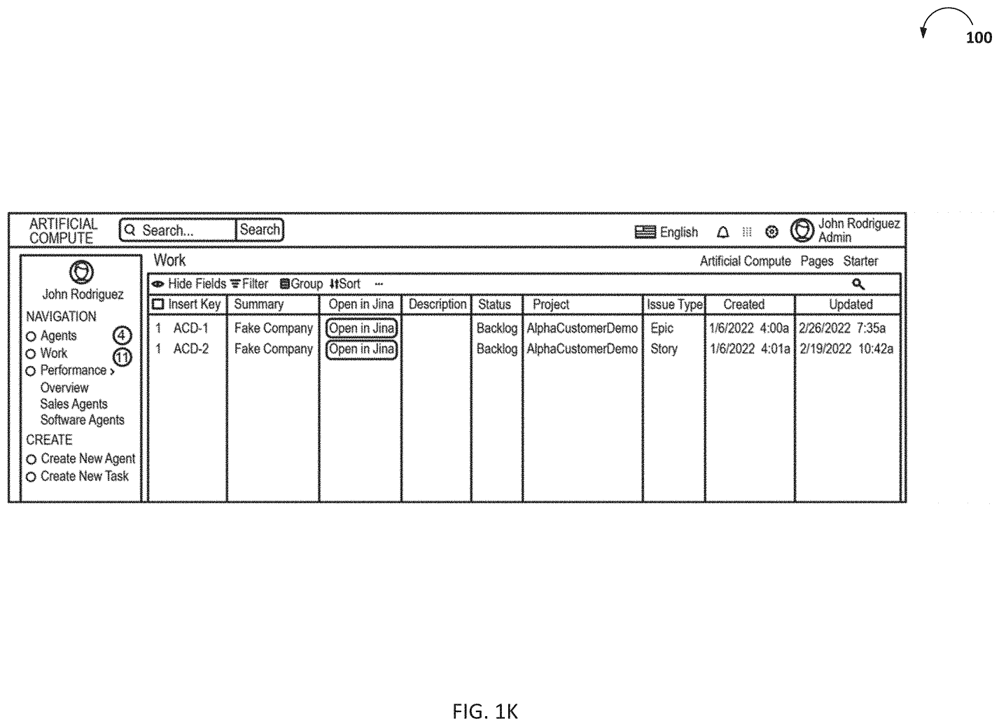

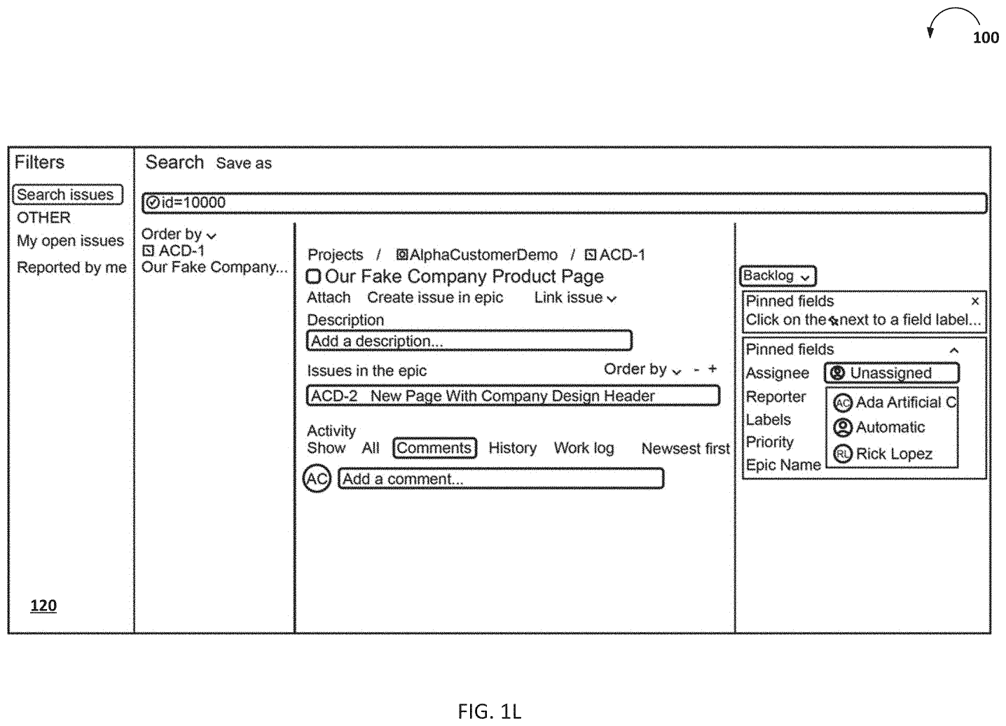

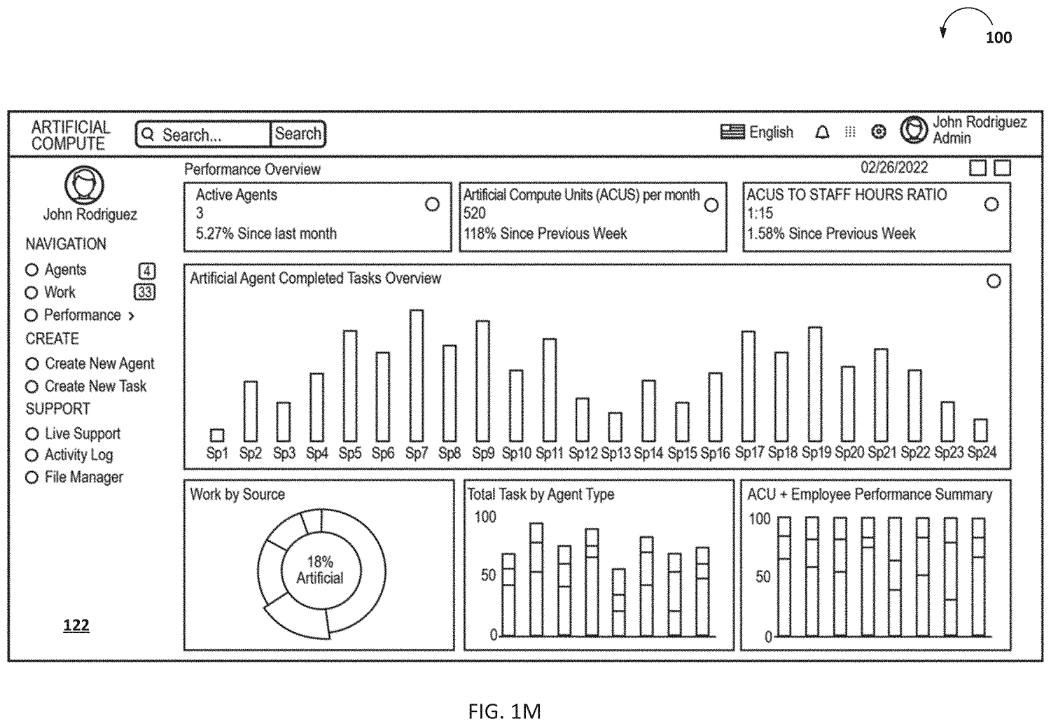

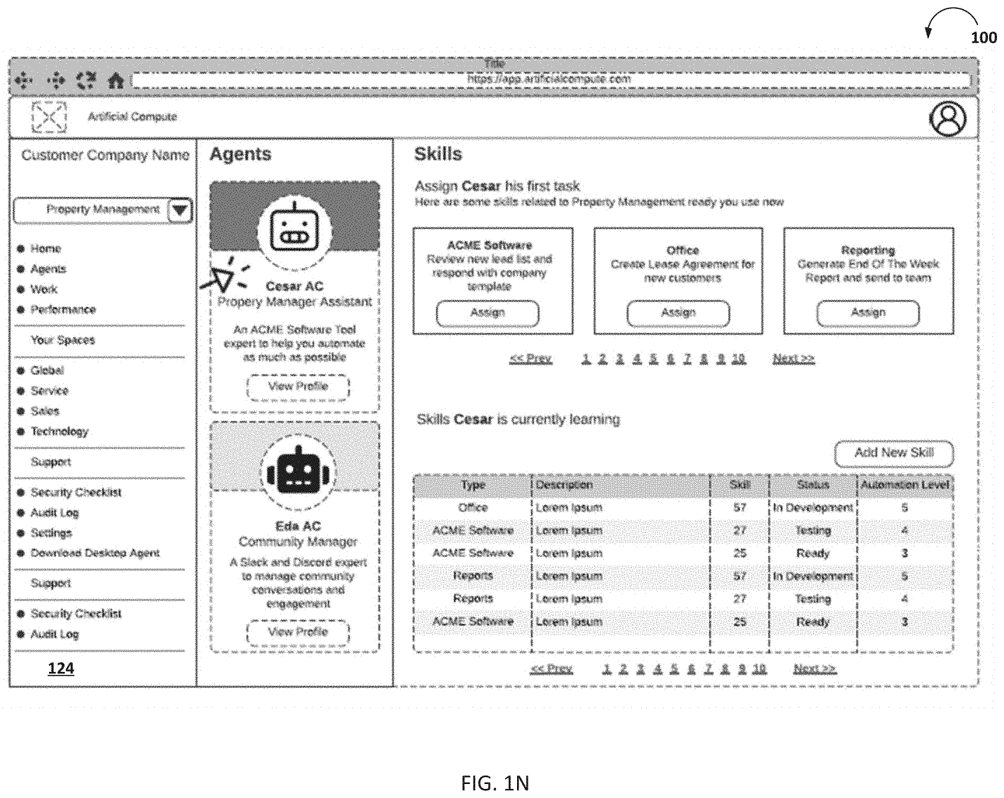

FIG. 1A illustrates an embodiment of the artificial compute agent creation process. Display 100 shown on an electronic device (e.g., computing device 102) includes a graphical user interface 104 for a user to navigate through one or more screens to generate an artificial compute agent. In FIG. 1B, a “create” section 106 includes a drop-down menu 108 provides a selectable menu indicating a type of artificial compute agent to be generated. As seen in FIG. 1C for example, a user can generate a software developer, sales agent, designer, marketing agent, customer service agent, data entry agent, and others. A description of the types of tasks and responsibilities to be handled by the artificial compute agent can be entered in the text box for “success description.” After selection of the type of an artificial compute agent, a “onboard” section 110 is shown in FIG. 1D. In section 110, the user may enter the user's contact information, preferred contact method, and documentation. In some embodiments, the documentation uploaded by the user is used to generate the commands and tasks performed by the artificial compute agent. Relevant data integration points may be provided to an artificial intelligence or machine learning model and serve as data ingestion points. In section “review and finish” 112 shown in FIG. 1E, the artificial compute agent has been generated and is ready for deployment. Details including the name of the artificial compute agent, its email address, and other information is displayed.

FIG. 1F illustrates display 100 shown on an electronic device 102 including a graphical user interface 104 displaying a chat screen 114 between an artificial compute agent 116 and a user. The details of the artificial compute agent 116 can be seen in FIG. 1G and includes contact information such as an email address, a GitHub™ account name, the language spoken, and any affiliated groups. In some embodiments, the generated artificial compute agent needs further direction or guidance to complete tasks. FIG. 1H illustrates an artificial desk 118 where a user (e.g., human) can input details and “train” the artificial compute agent. In some embodiments, the user does not interact with the artificial compute agent but rather provides a file that is analyzed by an artificial intelligence or machine learning model and applied to the artificial compute agent. For example, a user provides a slide deck explaining the process for submitting an expense report. The provided slide deck is analyzed by a machine learning algorithm and the contents of which are applied, or provided to the artificial compute agent to “train” the agent in the process for submitting an expense report. In some embodiments, a user may deploy multiple artificial compute agents such as the artificial compute agent “Allen” shown in FIG. 1I. As shown in FIGS. 1J and 1K, display 100 shows graphical user interface 104 providing a dashboard view of multiple artificial compute agents as they progress through the training and deployed states, as well as the ability to filter through the artificial compute agents by desired statistic or ability. In some embodiments, the artificial compute agents are operating in different states (e.g., geographically and/or temporally).

FIG. 1K includes a display 100 providing a graphical user interface 104 displaying an embodiment for viewing the statuses of one or more artificial compute agents. Different artificial compute agents are able to tackle different tasks. For example, a data entry artificial compute agent may pull data from a database, format it into an excel spreadsheet, and provide a report based on the data. A software developer artificial compute agent may write code for updating a position of a robotic arm. Each artificial compute agent can complete different tasks and work in parallel with another agent. Similarly, each artificial agent can be assigned to different projects.

FIG. 1L illustrates a graphical user interface 120 displaying a process for integration with third-party tools and services that are used for completing and defining tasks. FIG. 1M illustrates a graphical user interface 122 that provides performance metrics such as data for comparing non-human worker to human worker contribution and performance. FIG. 1N illustrates a graphical user interface 124 that provides a list of skills and tasks that artificial compute agent “Cesar” is able to perform and currently learning. This list may grow as “Cesar” is deployed and used to perform daily tasks.

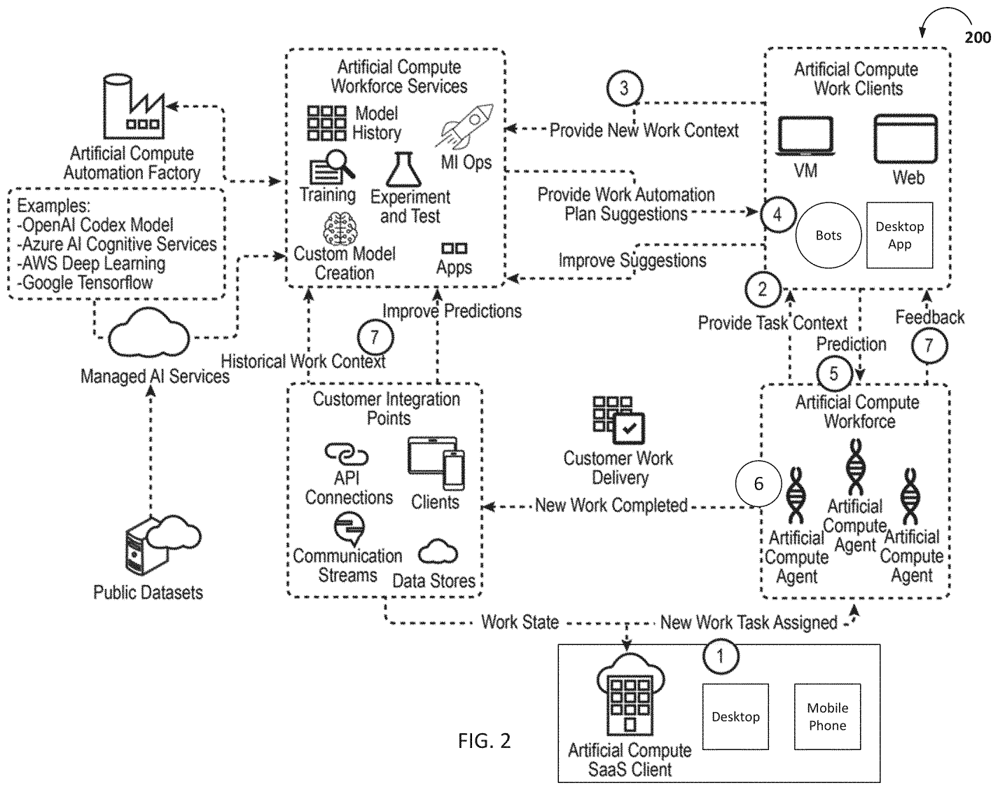

FIG. 2 is a block diagram illustrating the process for generating and deploying an artificial compute agent in accordance with some embodiments. In some embodiments, an example computing system for implementing artificial compute agents includes one or more processors coupled to system memory, an input/output device interface, a network interface, a server system, a database, and one or more electronic devices (e.g., client devices). Generating the artificial compute agents is expected to be performed by the computing system including at a user device (e.g., a client device). The user device is expected to communicate with one or more servers to generate the model (e.g., artificial compute agent) including through various application program interfaces (APIs) of various AI managed services and the servers representing such managed services. The user device is expected to communicate with such servers via a network interface such as the Internet, a local area network (LAN), a wide area network (WAN), a cellular communications network, or the like. The client device is expected to receive and store the generated model via suitable communication protocols described herein.

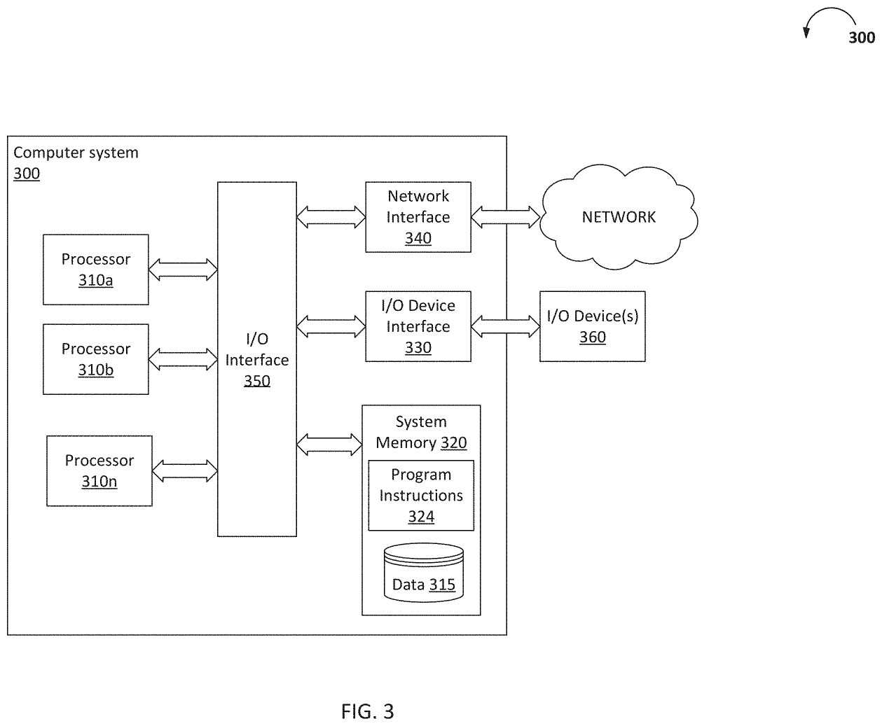

FIG. 3 illustrates an example of a computer system by which the present techniques may be implemented in accordance with some embodiments. Various portions of systems and methods described herein, may include or be executed on one or more computer systems similar to computing system 300. Further, processes and modules described herein may be executed by one or more processing systems similar to that of computing system 300.

Computing system 300 may include one or more processors (e.g., processors 1010a-1010n) coupled to system memory 320, an input/output I/O device interface 330, and a network interface 340 via an input/output (I/O) interface 350. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 300. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 320). Computing system 300 may be a uni-processor system including one processor (e.g., processor 310a), or a multi-processor system including any number of suitable processors (e.g., 310a-310n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 300 may include a plurality of computing devices (e.g., distributed computer systems) to implement various processing functions.

I/O device interface 330 may provide an interface for connection of one or more I/O devices 360 to computer system 300. I/O devices may include devices that receive input (e.g., from a user) or output information (e.g., to a user). I/O devices 360 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 360 may be connected to computer system 300 through a wired or wireless connection. I/O devices 360 may be connected to computer system 300 from a remote location. I/O devices 360 located on remote computer system, for example, may be connected to computer system 300 via a network and network interface 340.

Network interface 340 may include a network adapter that provides for connection of computer system 300 to a network. Network interface 340 may facilitate data exchange between computer system 300 and other devices connected to the network. Network interface 340 may support wired or wireless communication. The network may include an electronic communication network, such as the Internet, a local area network (LAN), a wide area network (WAN), a cellular communications network, or the like.

System memory 320 may be configured to store program instructions 324 or data 315. Program instructions 324 may be executable by a processor (e.g., one or more of processors 310a-310n) to implement one or more embodiments of the present techniques. Instructions 324 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 320 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 320 may include a non-transitory computer readable storage medium that may have program instructions stored thereon that are executable by a computer processor (e.g., one or more of processors 310a-310ₙ) to cause the subject matter and the functional operations described herein. A memory (e.g., system memory 320) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 350 may be configured to coordinate I/O traffic between processors 310a-310n, system memory 320, network interface 340, I/O devices 360, and/or other peripheral devices. I/O interface 350 may perform protocol, timing, or other data transformations to convert data signals from one component (e.g., system memory 320) into a format suitable for use by another component (e.g., processors 310a-310ₙ). I/O interface 350 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 300 or multiple computer systems 300 configured to host different portions or instances of embodiments. Multiple computer systems 300 may provide for parallel or sequential processing/execution of one or more portions of the techniques described herein.

Those skilled in the art will appreciate that computer system 300 is merely illustrative and is not intended to limit the scope of the techniques described herein. Computer system 300 may include any combination of devices or software that may perform or otherwise provide for the performance of the techniques described herein. For example, computer system 300 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 300 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 300 may be transmitted to computer system 300 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

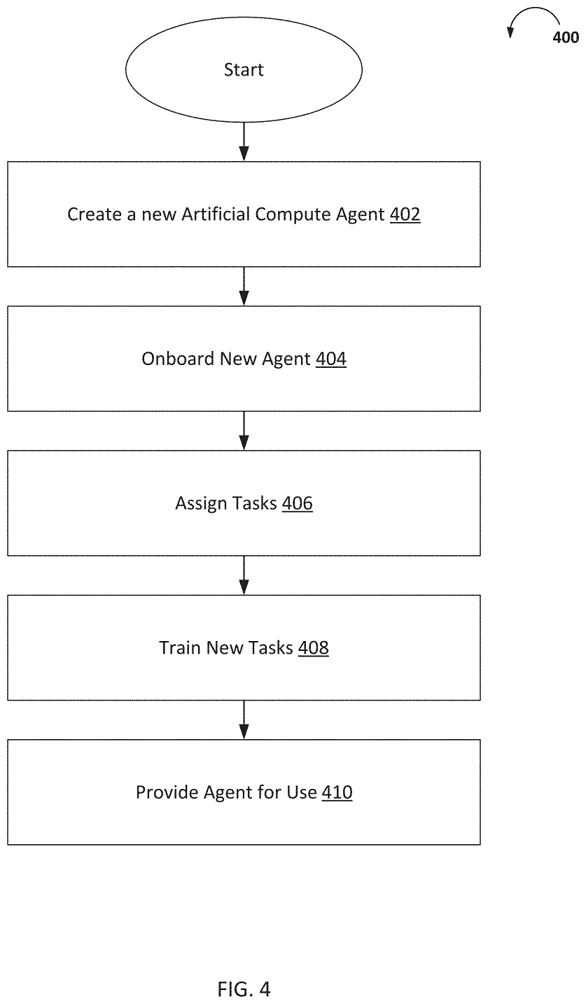

FIG. 4 illustrates a flow diagram of method 400 depicting the steps in generating an artificial compute agent. Method 400 begins by creating a new artificial compute agent at step 402. Input data includes what a user would typically provide in a job description such as a business description, job title, job requirements, and daily task examples. The new artificial compute agent is onboarded at step 404. The new agent is onboarded like a human employee and is provided with documentation on how tasks are to be included (e.g., via training documents, videos, audio). The new artificial compute agent is then provided tasks at step 406. The agent is provided with context of the job description and tasks in the previous steps of the method. The agent may receive recommendations on how to initialize tasks (e.g., by a user). After the agent completes one or more tasks, the agent is trained at step 408. In some embodiments, the agent is trained on the tasks it did not complete in a satisfactory manner, or on new tasks. The system may provide the agent with suggested new tasks based on the job description, user input, or other appropriate feedback. After the artificial compute agent has performed tasks and has received training, the artificial compute agent is ready for deployment. Customers (e.g., users) may now “go live” with the artificial compute agent in completing tasks in accordance with the job. In some embodiments, the steps of method 400 may be repeated to generate more artificial compute agents. In some embodiments, all or part of the steps of method 400 may be implemented in the order shown in FIG. 4. It is also contemplated that the steps may be performed in various orders and steps may be added or removed from method 400.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

Some embodiments define artificial compute agents and deploy artificial compute agents. Some embodiments receive requests for artificial compute agents and provide specific artificial compute agents per the received requests. The platform, in some embodiments, may provide proposals on how to achieve a desired outcome (e.g., a proposal including a combination of human, non-human, and automation software to perform a specified task). The platform, in some embodiments, may monitor and maintain a log of past completed tasks and which non-human (e.g., artificial compute agent) had completed said task. In some embodiments, the artificial compute agent is a chatbot, a virtual assistant, a mechanical robot, a software program, or any other suitable non-human intelligent agent.

Some systems offer options to hire human workers or purchase tools to help human employees with their work. In some cases, systems exists to help match work requirements to temporary workers (e.g., freelancers, contractors, and consultants). However, there are significant turnover costs associated with these options. As human workers turnover, direct recruiting costs are incurred. Also, tribal knowledge and time-to-value costs are lost. Some embodiments are expected to provide for a non-human worker that allows for the reduction of tribal knowledge transfer and reduces time-to-value addition of non-human workers.

Some embodiments implement a software-as-a-service (SaaS) platform that facilitates the creation, training, and deployment of an artificial workforce. An artificial workforce can include non-human workers (e.g., artificial intelligence) software that is tailored to provide services comparable to a human worker. Companies are expected to be able to build a new-age workforce, where machines and AI are non-human co-workers such as software developers, in some embodiments.

Some systems do not provide an integrated environment in which to a) select and identify potential non-human employees, b) analyze and review historical employee work activity or data logs of monitored worker activity that provides a pattern template and/or prediction for completing similar work, and c) and enable collaboration of artificial intelligence, automation software, and crowdsourcing to complete tasks as one unit. A system capable of creating, selecting, and deploying non-human employees is expected to significantly improve workflow processes and decrease costs associated with hiring and talent development.

Some embodiments, implement non-human workers to complete various tasks. To complete various tasks, in some embodiments, a system or platform operating on a processor may receive a plurality of task requests and requirements to be complete by artificial intelligence, automation techniques, and or human intelligence, with a plurality of skills and technologies. In some instances, the system generates a proposal to include one or more options for fulfilling and completing the task request, such as completion by AI, completion by automation software, and or a human worker. In some instances, the system further determines a cost associated with each of the options and generates the proposal to include the respective costs.

Artificial compute agents may be configured with a variety of techniques. In some embodiments, the AI models are large language models or other types of models, like convolutional neural networks, long-short-term memory models, decision trees, classification trees, Bayesian decision networks, or the like. In some embodiments, foundational model is configured to perform a specific task responsive to user input. Some embodiments subject the model to fine-tuning based on examples. Some embodiments adjust a foundational model with reinforcement learning with human feedback from the user. Some embodiments configure preambles for prompts to implement artificial compute agents, e.g., injecting text like, “you are a diligent, compassionate human-resources manager with a dozen years of experience, who writes clearly and concisely” before requests received from users for an HR manager artificial compute agent. In some cases, such configured artificial compute agents may be stored and executed server side, e.g., responsive to input from a client computing device by a remote server system. Or some embodiments may deploy such agents on a user's computing device.

Some embodiments may include system memory including a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random-access memory (SRAM), synchronous dynamic RAM (SDRAM)), bulk storage memory (e.g., CD-ROM and/or DVD-ROM, hard-drives), or the like.

Some embodiments are expected to reduce dependency on human talent and the cost of transferring job-specific knowledge. A benefit of non-human workers is expected to include a lack of hiring (ramp up) costs, a lack of termination costs, a lack of benefit premiums, and an overall lack of human worker liability costs. In addition, the data models created for non-human workers belong and can be retained by customers indefinitely, reducing the skills and knowledge loss when human employee turnover occurs.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description is not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square,” “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish, or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

What is claimed is:

1. A tangible, non-transitory, machine-readable medium storing instructions that when executed by one or more processors effectuate operations, comprising:
receiving, from a computing device, a request for an agent, the request including a set of one or more tasks to be automatically completed by the agent;
obtaining, from a database associated with the computing device, one or more preconfigured commands for performing the set of one or more tasks;
generating, using the one or more preconfigured commands, a virtual agent configured to perform the one or more preconfigured commands; and
providing an indication that the agent is configured to perform the set of one or more tasks and available for deployment.

2. The medium of claim 1, the operations further comprising:
receiving a request for changing performance of the agent; and
updating at least one of the set of one or more tasks based upon the received request.

3. The medium of claim 1, wherein the request for the agent further comprises a sample output of the set of one or more tasks, the sample output including one or more text, audio, image, and video.

4. The medium of claim 1, the operations further comprising generating an executable set of computer code for one or more commands in accordance with a determination that the database does not include one or more preconfigured commands configured to perform at least one of the one or more tasks.

5. The medium of claim 1, the operations further comprising generating a text document including text describing each of the one or more tasks of the set of one or more tasks to be performed by the agent.

6. The medium of claim 1, the operations further comprising assigning a score associated with an automation level for each of the one or more tasks.

7. The medium of claim 1, the operations further comprising providing, for each task of the set of one or more tasks, a prediction score associated with a probability that completion of the task requires human intervention.

8. The medium of claim 1, the operations further comprising:
determining the database does not have at least one command for performing the set of tasks; and
based on the determining, generating a command for performing the task of the set of tasks using an artificial intelligence (AI) model.

9. The medium of claim 1, the operations further comprising generating an updated version of the command by providing a video input into the AI model.

10. The medium of claim 1, the operations further comprising generating an updated version of the command by providing an audio input into the AI model.

11. The medium of claim 1, the operations further comprising generating an updated version of the command by providing inputs of human interactions with computer software into the AI model.

12. The medium of claim 1, the operations further comprising training the AI model by providing human user input to generate updated versions of commands.

13. A method, comprising:
receiving a request for an agent, the request including a set of one or more tasks to be automatically completed by the agent;
obtaining, from a database, one or more preconfigured commands for performing the set of one or more tasks;
generating, using the one or more preconfigured commands, a virtual agent configured to perform the one or more preconfigured commands; and
providing an indication that the agent is configured to perform the set of one or more tasks and available for deployment.

14. The method of claim 13, further comprising assigning a score associated with an automation level for each of the one or more tasks.

15. The method of claim 13, further comprising providing, for each task of the set of one or more tasks, a prediction score associated with a probability that completion of the task requires human intervention.

16. The method of claim 13, further comprising:
determining the database does not have at least one command for performing the set of tasks; and
based on the determining, generating a command for performing the task of the set of tasks using an artificial intelligence (AI) model.

17. The method of claim 16, further comprising generating an updated version of the command by providing a video input or an audio input into the AI model.

18. The method of claim 16, further comprising generating an updated version of the command by providing inputs of human interactions with computer software into the AI model.

19. The method of claim 16, further comprising training the AI model by providing human user input to generate updated versions of commands.

20. The method of claim 16, further comprising steps for providing artificial compute agents.
